(19) United States
(12) Patent Application Publication
(10) Pub. No.: US 2026/0251366 A1
(43) Pub. Date: Aug. 27, 2026

(54) System and method for charging a phase change material (PCM) tank for pressure control at a flash tank

(71) Applicant: Lennox Industries Inc., Richardson, TX (US)

(72) Inventors: Suyambu Lingam Arumugam, Tirunelveli (IN); Kowsalya N, Tamil Nadu (IN)

(21) Appl. No.: 19/065,414

(22) Filed: Feb. 27, 2025

(51) Int. Cl. F25B 45/00; C09K 5/04; F25B 41/20; F25B 41/31

(52) U.S. Cl. CPC F25B 45/00; F25B 41/20; F25B 41/31; C09K 5/041; F25B 2345/003; F25B 2400/16; F25B 2400/24; F25B 2600/2523; F25B 2700/19; F25B 2700/2111

(57) ABSTRACT

A refrigeration system comprises a controller and a phase change material (PCM) tank configured to store PCM to manage the pressure within a flash tank. The PCM tank has inlets and outlets fluidly coupled to the flash tank and internal tubes to facilitate heat exchange between the PCM and the refrigerant. The controller determines whether to operate in a charging cycle of the PCM tank based on pressure data that indicates a pressure of refrigerant within the flash tank. If the pressure of the refrigerant is less than a threshold pressure level, the controller communicates a signal to at least partially open a valve to allow the refrigerant in liquid form to flow from the flash tank to the PCM tank. The refrigerant absorbs heat from the PCM, the PCM transitions into a solid phase, the refrigerant changes into vapor and flows toward a suction line of a compressor.

### TECHNICAL FIELD

This disclosure relates generally to refrigeration systems. More particularly, this disclosure relates to the system and method for charging a Phase Change Material (PCM) tank for pressure control at a flash tank.

### BACKGROUND

Cooling systems are used to cool spaces, such as residential dwellings, commercial buildings, and/or refrigeration units. These systems cycle a refrigerant (also referred to as charge) that is used to cool the spaces.

### SUMMARY OF THE DISCLOSURE

Some conventional refrigeration systems use auxiliary cooling units to manage the standstill pressure of their flash tanks during power failures or during maintenance periods. For example, some conventional refrigeration systems use dedicated active cooling units to cool the high-pressure, high-temperature refrigerant from the flash tanks. The term ‘active’ with respect to cooling units means that the dedicated cooling units require electrical power to operate. The dedicated active cooling units include heat exchangers (e.g., brazed plate heat exchangers (BPHEs)) and condensing units (CDUs) which are powered by power generators or inverter circuitries. In some cases, some approaches to utilize dedicated active cooling units to manage the standstill pressure within flash tanks suffer from drawbacks. For example, some dedicated active cooling units reduce the energy efficiency of the refrigeration system as they require additional energy/power to operate. In another example, some auxiliary cooling units use other refrigerants, such as hydrofluorocarbon (HFC) which is different compared to the primary CO₂ refrigerant used by the refrigeration system. Using other refrigerants requires additional hardware integration of pipes or conduits with the CO₂ refrigerant in the refrigeration system. The additional hardware integration of pipes or conduits to operate the auxiliary cooling units increases the design complexity of the refrigeration system integrated with auxiliary cooling units.

The disclosed system provides a technical solution to these and other technical problems of conventional refrigeration systems. In some embodiments, the disclosed system obviates the need for dedicated active cooling units by integrating a phase change material (PCM) tank system into the CO₂ refrigeration system. The PCM is a material that can change phases between solid, liquid and/or gas, such as water. The PCM tank system is passive—meaning that it does not require electrical power to operate. This leads to reducing the power consumption that would otherwise be required by the active cooling units in conventional systems. The disclosed system leverages the available CO₂ refrigerant which is already cooled during the normal cooling operation of the refrigeration system to charge the PCM within the PCM tank system. The term ‘charging’ refers to cooling the PCM to below or at its freezing temperature. Therefore, the disclosed system adds an additional function to the CO₂ refrigerant by using it to cool the PCM to use it for future needs in pressure regulation of the flash tank. In the event of a power failure, maintenance period, or the pressure of the flash tank increases more than a threshold pressure level, the disclosed system initiates the discharging cycle for the PCM tank to reduce the pressure of the flash tank to a predefined pressure level of the flash tank.

By leveraging the already available cooling capacity of the refrigeration system to generate thermal storage in the PCM tank, the disclosed system reduces the design complexity of the refrigeration system and reduces the energy requirement to run the refrigeration system.

### Operating The Refrigeration System in a Charging Cycle of the PCM Tank

In some embodiments, the refrigeration system comprises a PCM tank configured to store a PCM. The PCM is configured to change phases between liquid and solid phases. The PCM tank comprises a first inlet positioned downstream of a first outlet of a flash tank via a first valve; a first outlet positioned upstream of a first inlet of the flash tank via a second valve; a second inlet positioned downstream of a third valve, wherein the third valve is positioned downstream of a fourth valve which is fluidly connected to a second outlet of the flash tank; a second outlet positioned downstream of a suction line of a compressor; and an internal tube in which refrigerant is stored. The refrigeration system further comprises the flash tank fluidly coupled with the PCM tank, and configured to store a mixture of refrigerant in vapor form and liquid form. The refrigeration system further comprises the third valve configured to expand the refrigerant as the refrigerant flows through the third valve, thereby causing the temperature of the refrigerant to be reduced. The refrigeration system further comprises a pressure sensor circuit positioned within the flash tank, and configured to detect a pressure of the refrigerant within the flash tank.

The refrigeration system further comprises a controller operably coupled with the pressure sensor circuit. The controller comprises a processor configured to receive pressure data from the pressure sensor circuit, wherein the pressure data indicates the pressure of the refrigerant within the flash tank. The processor is further configured to determine whether to operate in a charging cycle of the PCM tank based at least in part upon the received pressure data, wherein determining whether to operate in the charging cycle of the PCM tank comprises determining that the pressure of the refrigerant is less than a threshold pressure level. The processor is further configured to communicate a first electronic signal to the fourth valve to at least partially open the fourth valve to allow the refrigerant in liquid form to flow from the flash tank to the second inlet of the PCM tank in response to determining to operate in the charging cycle of the PCM tank. In response to the fourth valve be at least partially opened, the refrigerant in liquid form flows from the flash tank toward the second inlet of the PCM tank via the fourth valve and the third valve; within the PCM tank, the refrigerant absorbs heat from the PCM and changes into vapor refrigerant; and the vapor refrigerant flows from the second outlet of the PCM toward the suction line of the compressor. During the charging cycle of the PCM tank, the first valve and the second valve are closed.

### Operating the Refrigeration System in a Discharging Cycle of the PCM Tank

In some embodiments, the refrigeration system comprises a PCM tank configured to store a PCM, the PCM configured to change phases between liquid and solid phases. The PCM tank comprises a first inlet positioned downstream of a first outlet of a flash tank via a first valve; a first outlet positioned upstream of a first inlet of the flash tank via a second valve; a second inlet positioned downstream of a third valve, wherein the third valve is positioned downstream of a fourth valve which is fluidly connected to a second outlet of the flash tank; a second outlet positioned downstream of a suction line of a compressor; and an internal tube in which refrigerant is stored. The refrigeration system further comprises the flash tank fluidly coupled with the PCM tank, and configured to store a mixture of refrigerant in vapor form and liquid form. The refrigeration system further comprises the third valve configured to expand the refrigerant as the refrigerant flows through the third valve, thereby causing a temperature of the refrigerant to be reduced.

The refrigeration system further comprises a controller comprising a processor configured to determine that a condition to operate in a discharging cycle of the PCM tank is met. The processor is further configured to communicate a first electronic signal to the fourth valve to close the fourth valve in response to determining that the condition to operate in the discharging cycle of the PCM tank is met. During the discharging cycle of the PCM tank, the refrigerant in vapor form flows from the first outlet of the flash tank toward the first inlet of the PCM tank via the first valve; the PCM absorbs heat from the refrigerant flown from the flash tank, causing a temperature of the refrigerant to reduce; and the refrigerant with a reduced temperature flows from the first outlet of the PCM tank toward the first inlet of the flash tank via the second valve, wherein during the discharging cycle of the PCM tank, the first valve and the second valve are open, and the third valve is closed. In some case whenever there is a power failure, the first valve inlet and outlet will open while the second valve inlet and outlet are closed. The refrigerant vapor from the flash tank will flow to the refrigerant tubes of the PCM tank and get cooled by stored PCM. This makes the refrigerant vapor get cooled and return back as a liquid vapor mixture by thermosyphon effect. Thus, the flash tank's pressure is reduced and the PCM melts.

Certain embodiments of the present disclosure may include some, or none of these advantages. These advantages and other features will be more clearly understood from the following detailed description taken in conjunction with the accompanying drawings and claims.

### BRIEF DESCRIPTION OF THE DRAWINGS

For a more complete understanding of the present disclosure, reference is now made to the following description, taken in conjunction with the accompanying drawings, in which:

FIG. 1 illustrates a diagram of an embodiment of a refrigeration system, according to some embodiments of the present disclosure;

FIG. 2 illustrates a flowchart of an example embodiment of a Phase Change Material (PCM) tank of the refrigeration system of FIG. 1;

FIG. 3A illustrates an example of an operational flow of the refrigeration system during a charging cycle of the PCM tank of the refrigeration system of FIG. 1;

FIG. 3B illustrates an example of an operational flow of the refrigeration system during a discharging cycle of the PCM tank of the refrigeration system of FIG. 1;

FIG. 4 illustrates a flowchart of an example method for operating the refrigeration system of FIG. 1 in a charging cycle of the PCM tank; and

FIG. 5 illustrates a flowchart of an example method for operating the refrigeration system of FIG. 1 in a discharging cycle of the PCM tank.

### DETAILED DESCRIPTION

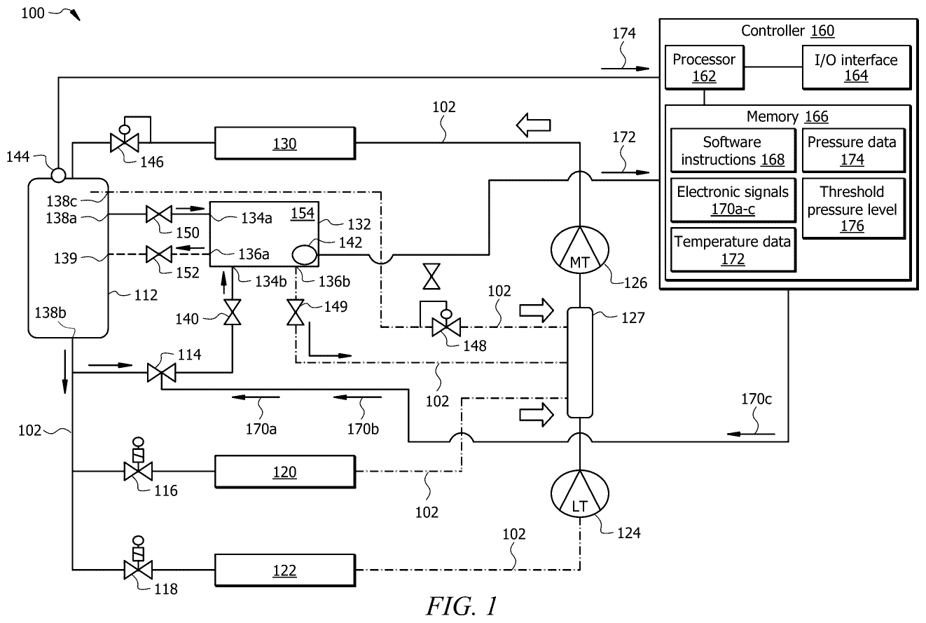

Embodiments of the present disclosure and its advantages are best understood by referring to FIGS. 1 through 5 of the drawings, like numerals being used for like and corresponding parts of the various drawings.

Some conventional refrigeration systems use auxiliary cooling units to manage the standstill pressure of their flash tanks during power failures or during maintenance periods. For example, some conventional refrigeration systems use dedicated active cooling units to cool the high-pressure, high-temperature refrigerant from the flash tanks. The term ‘active’ with respect to cooling units means that the dedicated cooling units require electrical power to operate. The dedicated active cooling units include heat exchangers (e.g., brazed plate heat exchangers (BPHEs)) and condensing units (CDUs) which are powered by power generators or inverter circuitries. In some cases, some approaches to utilize dedicated active cooling units to manage the standstill pressure within flash tanks suffer from drawbacks. For example, some dedicated active cooling units reduce the energy efficiency of the refrigeration system as they require additional energy/power to operate. In another example, some auxiliary cooling units use other refrigerants, such as hydrofluorocarbon (HFC) different compared to the primary CO₂ refrigerant used by the refrigeration system. Using other refrigerants requires additional hardware integration of pipes or conduits with the CO₂ refrigerant in the refrigeration system. The additional hardware integration of pipes or conduits to operate the auxiliary cooling units increases the design complexity of the refrigeration system integrated with auxiliary cooling units.

The disclosed system provides a technical solution to these and other technical problems of conventional refrigeration systems. In some embodiments, the disclosed system obviates the need for dedicated active cooling units by integrating a phase change material (PCM) tank system into the CO₂ refrigeration system. The PCM is a material that can change phases between solid, liquid and/or gas, such as water. The PCM tank system is passive—meaning that it does not require electrical power to operate. This leads to reducing the power consumption that would otherwise be required by the active cooling units in conventional systems. The disclosed system leverages the available CO₂ refrigerant which is already cooled during the normal cooling operation of the refrigeration system to charge the PCM within the PCM tank system. The term ‘charging’ refers to cooling the PCM to below or at its freezing temperature. Therefore, the disclosed system adds an additional function to the CO₂ refrigerant by using it to cool the PCM to use it for future needs in pressure regulation of the flash tank. In the event of a power failure, maintenance period, or the pressure of the flash tank dropping to less than a threshold pressure level, the disclosed system initiates the discharging cycle for the PCM tank to reduce the pressure of the flash tank to a predefined pressure level of the flash tank.

By leveraging the already available cooling capacity of the refrigeration system to generate thermal storage in the PCM tank, the disclosed system reduces the design complexity of the refrigeration system and reduces the energy requirement to run the refrigeration system.

### Refrigeration System

FIG. 1 illustrates an example refrigeration system 100 according to an embodiment of the present disclosure. In general, the refrigeration system 100 is configured to manage and control the pressure level of a flash tank 112 by a PCM tank 132. In some embodiments, the refrigeration system 100 comprises refrigerant conduit subsystems 102, the flash tank 112, valves 114, 116, 118, 140, 146, 148, 149, 150, and 152, a medium-temperature (MT) indoor heat exchanger 120, a low-temperature (LT) indoor heat exchanger 122, an LT compressor 124 (such as a booster compressor), an MT compressor 126, an outdoor heat exchanger 130, the PCM tank 132, temperature sensor circuits 142, pressure sensor circuits 144, and a controller 160.

In some embodiments, the refrigeration system 100 is a transcritical refrigeration system that circulates a working fluid or charge, such as a transcritical refrigerant (e.g., CO₂). The illustrated embodiment of the refrigeration system 100 in FIG. 1 is configured to provide air conditioning for one or more target spaces for one or more applications, such as low-temperature applications (e.g., freezing applications) and medium-temperature applications (e.g., for display cases in stores). In some embodiments, the refrigeration system 100 may include one or more of each of the illustrated components operably coupled to one another. In some embodiments, the refrigeration system 100 may include additional components.

### System Components

The refrigerant conduit subsystems 102 facilitate the movement of a refrigerant (also referred to herein as a working fluid) through a refrigeration cycle such that the working fluid flows as illustrated by arrows in FIG. 1. The refrigerant conduit subsystem 102 includes any conduit, tubing and the like that is illustrated in FIG. 1 fluidly connecting components of the refrigeration system 100.

The flash tank 112 may generally be a storage component to store a mixture of refrigerant in vapor and liquid forms. The flash tank 112 is fluidly coupled to the refrigerant conduit subsystem 102 and is positioned downstream of the outdoor heat exchanger 130 (via the valve 146). The flash tank 112 may be configured to separate the refrigerant into a vapor refrigerant and a liquid refrigerant. Typically, the vapor refrigerant collects near the top of the flash tank 112 and the liquid refrigerant is collected at the bottom of the flash tank 112. In some embodiments, during providing conditioning according to a conditioning demand, the liquid refrigerant flows from flash tank 112 toward the MT indoor heat exchanger 120 and the LT indoor heat exchanger 122 (via the outlet 138b). Additionally, the vapor refrigerant (gas) flows from the flash tank 112 toward the MT compressor 126 (via the outlet 138c) to compress the vapor refrigerant and increase its pressure and temperature before it is directed toward the outdoor heat exchanger 130.

The valve 114 may generally be a switch valve, an expansion valve, a flow control valve, a flash gas valve, a solenoid valve, a motorized valve, a check valve, an electronic expansion valve (EEV), a thermal expansion valve (TXV), and the like. The valve 114 may be fluidly coupled to the refrigerant conduit subsystem 102 and located downstream of the flash tank 112 (via the outlet 138b) and upstream of the valve 140. The valve 114 may be configured to expand the refrigerant as the refrigerant flows through the valve 114, thereby causing the temperature of the refrigerant to be reduced. In some embodiments, the controller 160 may be in signal communication with the valve 114 (e.g., via wired and/or wireless communication) and control its operations. In some embodiments, the valve 114 may be mechanically calibrated to open and close based on design-specific refrigerant pressure differential across the valve and/or temperature set points. The valve 114 is configured to open and close by varying degrees to control the flow of the refrigerant discharged from flash tank 112.

Each of the valves 116 and 118 may generally be a switch valve, an expansion valve, a flow control valve, a flash gas valve, a solenoid valve, a motorized valve, a check valve, an EEV, a TXV, and the like. Each of the valves 116 and 118 may be fluidly coupled to the refrigerant conduit subsystem 102. Each of the valves 116 and 118 may be configured to open and close by varying degrees to control the flow of the refrigerant discharged from flash tank 112. The valve 116 may be positioned downstream of the flash tank 112 and upstream of the MT indoor heat exchanger 120. In some embodiments, the controller 160 may be in signal communication with the valve 116 (e.g., via wired and/or wireless communication) and control its operations. In some embodiments, the valve 116 may be mechanically calibrated to open and close based on design-specific refrigerant pressure across the valve and/or temperature set points. The valve 118 may be positioned downstream of the flash tank 112 and upstream of the LT indoor heat exchanger 122. In some embodiments, the controller 160 may be in signal communication with the valve 118 (e.g., via wired and/or wireless communication) and control its operations. In some embodiments, the valve 118 may be mechanically calibrated to open and close based on design-specific refrigerant pressure across the valve and/or temperature set points.

The MT indoor heat exchanger 120 may generally include one or more evaporator coils and fans to move air across the coils. The MT indoor heat exchanger 120 is fluidly coupled to the refrigerant conduit subsystems 102 and positioned downstream of the flash tank 112 and the valve 116. The MT indoor heat exchanger 120 may be in signal communication with the controller 160 using wired and/or wireless connections. The controller 160 may send control signals to the MT indoor heat exchanger 120 to control the speed of the fans based on temperature conditions and the cooling demand. The MT indoor heat exchanger 120 may be configured to receive the refrigerant from the flash tank 112 and absorb heat from the surrounding environment via the refrigerant received from the flash tank 112. The MT indoor heat exchanger 120 may function as an evaporator. When the refrigerant reaches the MT indoor heat exchanger 120, the refrigerant absorbs heat from the surrounding air in the target indoor space and releases cooled or conditioned air into the target space. For example, the refrigerant cools metallic components (e.g., metallic coils, plates, and/or tubes) of the MT indoor heat exchanger 120 as the refrigerant passes through them. These metallic components may then cool the air around them. The cooled air may then be circulated such as, for example, by a fan to cool a space such as, for example, a freezer and/or a refrigerated shelf. The MT indoor heat exchanger 120 may be for medium-temperature cooling applications, such as product shelves in stores. Therefore, the MT indoor heat exchanger 120 may provide air conditioning to the target space by transferring heat between the refrigerant and the target space.

The LT indoor heat exchanger 122 may generally include one or more evaporator coils and fans to move air across the coils. The LT indoor heat exchanger 122 is fluidly coupled to the refrigerant conduit subsystems 102 and positioned downstream of the flash tank 112 and the valve 118. The LT indoor heat exchanger 122 is in signal communication with the controller 160 using wired and/or wireless connections. The controller 160 may send control signals to the LT indoor heat exchanger 122 to control the speed of the fans based on temperature conditions and the cooling demand. The LT indoor heat exchanger 122 may be configured to receive the refrigerant from the flash tank 112 and absorb heat from the surrounding environment via the refrigerant received from the flash tank 112. The LT indoor heat exchanger 122 may function as an evaporator. When the refrigerant reaches the LT indoor heat exchanger 122, the refrigerant absorbs heat from the surrounding air in the target indoor space and releases cooled or conditioned air into the target space. For example, the refrigerant cools metallic components (e.g., metallic coils, plates, and/or tubes) of the LT indoor heat exchanger 122 as the refrigerant passes through them. These metallic components may then cool the air around them. The cooled air may then be circulated such as, for example, by a fan to cool a space such as, for example, a freezer and/or a refrigerated shelf. The LT indoor heat exchanger 122 may be for low-temperature cooling applications, such as freezers in stores. Therefore, the LT indoor heat exchanger 122 may provide air conditioning to the target space by transferring heat between the refrigerant and the target space.

The LT compressor 124 may be a variable speed compressor or a multiple-stage compressor and is generally configured to compress (e.g., increase the pressure of) the refrigerant received from the LT indoor heat exchanger 122. The LT compressor 124 may be configured to compress refrigerant for low-temperature applications, such as freezers, by increasing the refrigerant pressure. The LT compressor 124 is fluidly coupled with the refrigerant conduit subsystem 102 and may be positioned downstream of the LT indoor heat exchanger 122. The LT compressor 124 may be in signal communication with the controller 160 using wired and/or wireless connections. The controller 160 may communicate electronic signals to the LT compressor 124 to control its speed. A variable-speed compressor is generally configured to operate at different speeds to increase the pressure of the refrigerant to keep the refrigerant moving along the fluid conduit subsystem 102. In the variable-speed compressor configuration, the speed of LT compressor 124 can be modified to adjust the cooling capacity and/or load of the refrigeration system 100. Meanwhile, in the multi-stage compressor configuration, one or more compressors can be turned on or off to adjust the cooling capacity of the refrigeration system 100.

The MT compressor 126 may be a variable speed compressor or a multiple-stage compressor and generally configured to compress (e.g., increase the pressure of) the refrigerant received from the MT indoor heat exchanger 120, PCM tank 132, and/or flash tank 112. The MT compressor 126 may be configured to compress refrigerant for medium-temperature applications, such as for display items in stores, by increasing the refrigerant pressure. The MT compressor 126 is fluidly coupled with the refrigerant conduit subsystem 102 and positioned downstream of the MT indoor heat exchanger 120, PCM tank 132, and flash tank 112 (via the valve 148). The MT compressor 126 may be in signal communication with the controller 160 using wired and/or wireless connections. The controller 160 may communicate electronic signals to the MT compressor 126 to control the variable speed compressor's speed or turn on and off fixed speed compressors to maintain a constant or substantially constant suction pressure target. A variable-speed compressor is generally configured to operate at different speeds to increase the pressure of the refrigerant to keep the refrigerant moving along the fluid conduit subsystem 102. In the variable-speed compressor configuration, the speed of MT compressor 126 can be modified to adjust the cooling capacity and/or load of the refrigeration system 100. Meanwhile, in the multi-stage compressor configuration, one or more compressors can be turned on or off to adjust the cooling capacity of the refrigeration system 100.

The outdoor heat exchanger 130 may be a high-side heat exchanger, such as a gas cooler or a condenser, and generally includes one or more coils and fans to move the air across the coils. The outdoor heat exchanger 130 is fluidly coupled with the refrigerant conduit subsystem 102 and positioned downstream of the MT compressor 126 and upstream of the valve 146. The outdoor heat exchanger 130 is in signal communication with the controller 160 using wired and/or wireless connections. The controller 160 may send electronic signals to the outdoor heat exchanger 130 to control the speed of the fans based on temperature conditions and conditioning demand. The outdoor heat exchanger 130 is configured to transfer heat from the refrigerant into the surrounding outdoor environment. The outdoor heat exchanger 130 removes heat from the refrigerant when the refrigerant flows through the coils, allowing the refrigerant to release its absorbed heat into the outdoor environment. When heat is removed from the refrigerant, the refrigerant is cooled. The outdoor heat exchanger 130 may be operated as a condenser and/or a gas cooler. When operating as a condenser, outdoor heat exchanger 130 cools the refrigerant such that the state of the refrigerant changes from a gas to a liquid. When operating as a gas cooler, outdoor heat exchanger 130 cools gaseous refrigerant and the refrigerant remains a gas. In certain configurations, the outdoor heat exchanger 130 is positioned such that heat removed from the refrigerant may be discharged into the air in the surrounding environment. For example, the outdoor heat exchanger 130 may be positioned on a rooftop so that heat removed from the refrigerant may be discharged into the air. As another example, the outdoor heat exchanger 130 may be positioned external to a building and/or on the side of a building. This disclosure contemplates any suitable refrigerant (e.g., carbon dioxide) being used in the disclosed cooling systems. The refrigeration system 100 may include any appropriate number of outdoor heat exchangers 130 with the same or a similar configuration to that shown for the example of the outdoor heat exchanger 130 in FIG. 1.

The PCM tank 132 generally includes a thermally insulated enclosure configured to store a PCM and regulate the pressure level within the flash tank 112. The PCM is generally any material that can change phases between liquid, solid, and/or gaseous phases. In some examples, the PCM may include water or any other suitable materials. The PCM facilitates heat exchange with the refrigerant during charging and discharging cycles of the PCM tank 132. The PCM tank 132 is fluidly coupled to the refrigerant conduit subsystem 102 and therefore to the flash tank 112, among other components.

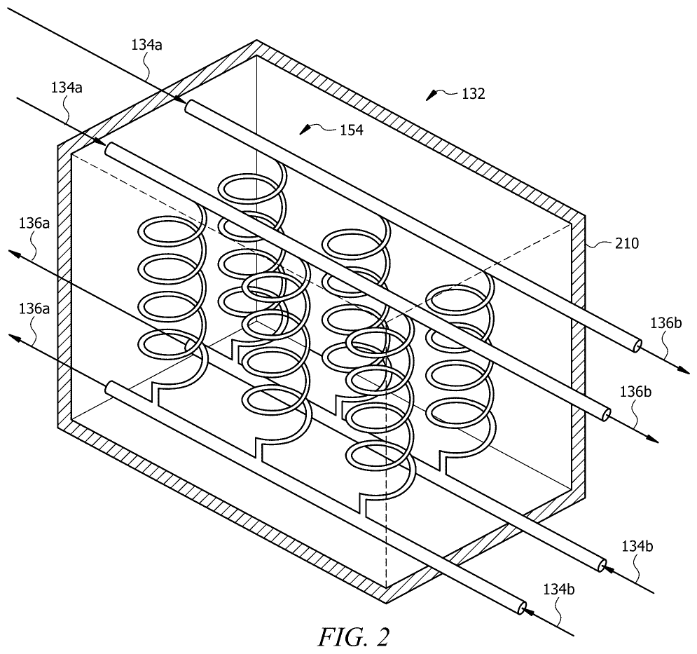

The PCM tank 132 comprises a first inlet 134a that is positioned downstream of a first outlet 138a of the flash tank 112 via the first valve 150, a first outlet 136a that is positioned upstream of a first inlet 139 of the flash tank 112 via a second valve 152, a second inlet 134b that is positioned downstream of the third valve 140 (where the third valve 140 is positioned downstream of the fourth valve 114 fluidly coupled to a second outlet 138b of the flash tank 112), and a second outlet 136b that is positioned upstream of the suction line 127 of the MT compressor 126. The PCM tank 132 further includes internal pipes or tubes 154 which are fluidly coupled with the refrigerant conduit subsystem 102 such that the refrigerant can flow from within the tubes 154 to refrigerant conduit subsystem 102, and vice versa. In some examples, the pipes or tubes 154 may be made of copper or copper alloy. The thermally insulated enclosure of the PCM tank 132 may be formed from polyurethane foam (PUF), for example. The PCM tank 132 is configured to operate in charging cycle to form and store cooled PCM and in discharging cycle to use the cooled PCM to reduce the temperature of the refrigerant received from the flash tank 112 and therefore the pressure of the refrigerant. The charging and discharging cycles of the PCM tank 132 are described below in conjunction with the operational flow of the system 100 in greater detail. An example embodiment of the PCM tank 132 is illustrated in FIG. 2.

Referring to FIG. 2, the illustrated embodiment of the PCM tank 132 includes the thermally insulated enclosure 210 which houses the PCM and internal tubes 154. The PCM may be stored around the tubes 154 within the enclosure 210 of the PCM tank 132. Therefore, the refrigerant flowing inside the tubes 154 and the PCM are thermally coupled and can exchange heat with each other. In some embodiments, the tubes 154 may be in a spiral configuration or any other configuration. As shown in FIG. 2, the tubes 154 are interconnected to allow the flow of the refrigerant through the inlets and outlets of the PCM tank 132 during each of the charging and discharging cycles of the PCM tank 132. For example, the first inlet 134a may be configured to receive refrigerant during the discharging cycle from the flash tank (112 in FIG. 1). The first outlet 136a may provide refrigerant in liquid form after the heat exchange, back to the flash tank during the discharging cycle. In another example, the second inlet 134b may be configured to receive refrigerant in liquid form during the charging cycle from the flash tank. The second outlet 136b provides refrigerant in vapor form, after absorbing heat from the PCM, to the suction line 127 of the MT compressor during the charging cycle.

Referring back to FIG. 1, the PCM tank 132 further includes one or more temperature sensor circuits 142 configured to detect the temperature of the PCM within the insulated enclosure of the PCM tank 132. The temperature sensor circuit 142 may include a temperature sensing element and circuitry. The temperature sensor circuit 142 may be implemented by a hardware circuit and configured to detect the temperature of the PCM. The temperature sensor circuit 142 may include one or more temperature sensor circuits 142. The temperature sensor circuit 142 may include a temperature sensing element such as a thermocouple, a thermistor, a semiconductor-based temperature circuit board, or any other type of temperature sensor. In some examples, the temperature sensor circuit 142 may be positioned within the PCM tank 132, a surface of the tube 154, or at any other location. The temperature sensor circuit 142 may be attached to a surface using any appropriate means (e.g., threaded connections, clamps, adhesives, or the like). The temperature sensor circuit 142 is configured to detect the temperature of the PCM periodically (e.g., every second, every minute, etc.) and/or on demand (e.g., in response to a request from the controller 160). The temperature sensor circuit 142 is in signal communication with the controller 160 using wired and/or wireless connections. The temperature sensor circuit 142 may provide the detected temperature data 172 (which includes the detected temperature of the PCM) to the controller 160. The controller 160 may use the temperature data 172 for evaluating whether to operate in the charging or discharging cycle of the PCM tank 132.

The valve 140 may generally be a switch valve, an expansion valve, a flow control valve, a flash gas valve, a solenoid valve, a motorized valve, a check valve, an EEV, a TXV, and the like. The valve 140 may be fluidly coupled to the refrigerant conduit subsystem 102 and positioned downstream of the valve 114 and upstream of the inlet 134b of the PCM tank 132.

The pressure sensor circuit 144 may include a pressure sensing element and circuitry. The pressure sensor circuit 144 may be implemented by a hardware circuit configured to detect the pressure of the refrigerant inside the flash tank 112. The pressure sensor circuit 144 may include one or more pressure sensor circuits 144. The pressure sensor circuit 144 may include a pressure sensing element, such as a diaphragm, a piezoelectric sensor, and/or any other type of pressure sensing circuit boards. The pressure sensor circuit 144 may be attached to a surface of the interior of the flash tank 112 using any appropriate means (e.g., threaded connections, clamps, adhesives, or the like). The pressure sensor circuit 144 is configured to detect (capture) the pressure of the refrigerant periodically (e.g., every second, every minute, etc.) and/or on demand (e.g., in response to a request from the controller 160). The pressure sensor circuit 144 is in signal communication with the controller 160 using wired and/or wireless connections. The pressure sensor circuit 144 may provide pressure data 174 that includes the detected pressure of the refrigerant to the controller 160. The controller 160 may use the pressure data 174 for evaluating whether to operate in charging or discharging cycle of the PCM tank 132.

Each of the valves 146, 148, and 149 may generally be a switch valve, an expansion valve, a flow control valve, a flash gas valve, a solenoid valve, a motorized valve, a check valve, an EEV, a TXV, and the like. The valve 146 may be fluidly coupled to the refrigerant conduit subsystem 102 and positioned downstream of the outdoor heat exchanger 130 and upstream of the flash tank 112. The valve 148 may be fluidly coupled to the refrigerant conduit subsystem 102 and positioned downstream of the outlet 138c of the flash tank 112 and upstream of the suction line 127 of the MT compressor 126. The valve 149 may be fluidly coupled to the refrigerant conduit subsystem 102 and positioned downstream of the outlet 136b of the PCM tank 132 and upstream of the suction line 127 of the MT compressor 126. Each of the valves 146, 148, and 149 may be configured to open and close by varying degrees to control the flow of the refrigerant.

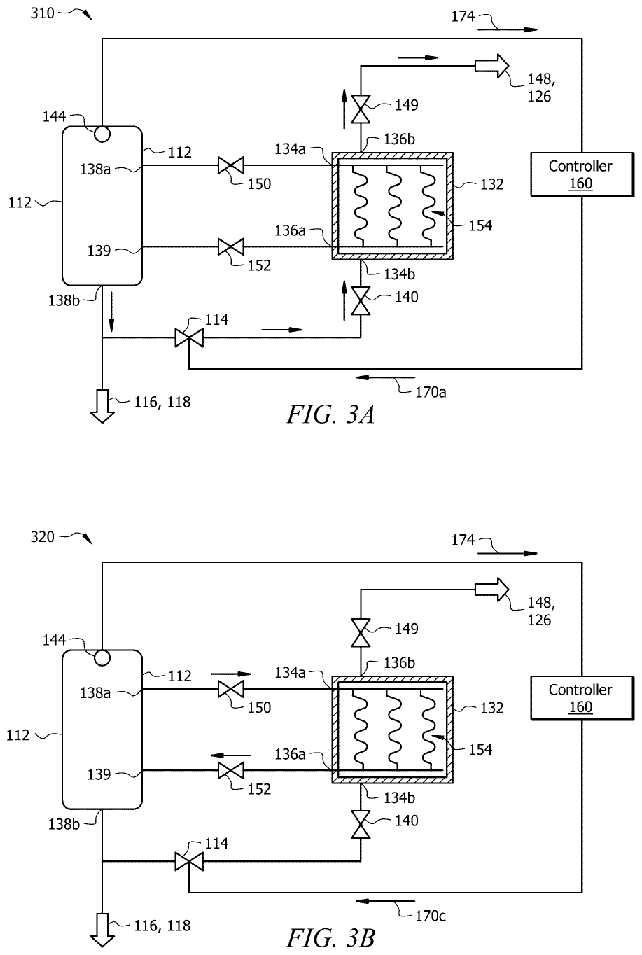

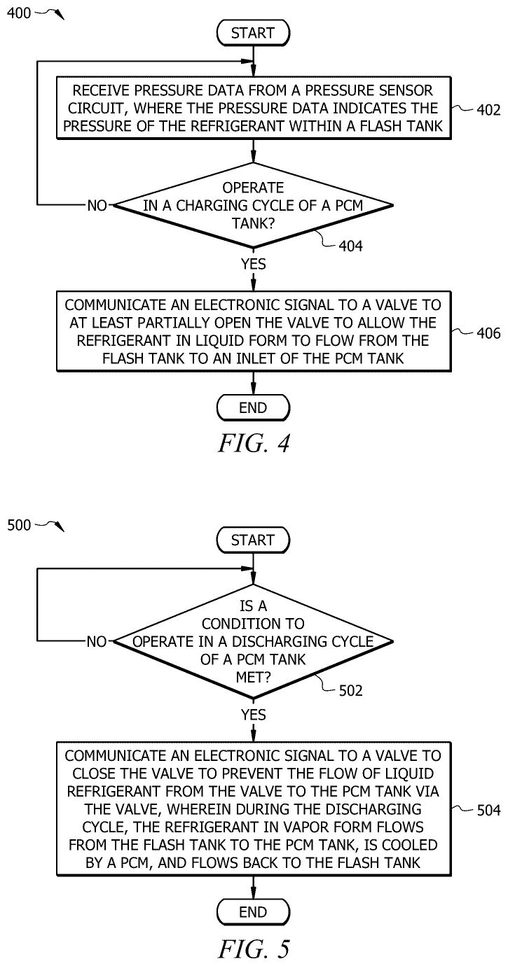

The controller 160 is communicatively coupled (e.g., via wired and/or wireless connection) to other components in the refrigeration system 100 and configured to control their operations. In some embodiments, controller 160 can be one or more controllers associated with one or more components of the refrigeration system 100. The controller 160 includes a processor 162 in signal communication with a memory 166 and an input/output (I/O) interface 164. The processor 162 comprises one or more processors. The processor 162 is any electronic circuitry including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs) that communicatively couples to memory 166 and controls the operation of refrigeration system 100. The processor 162 may be a programmable logic device, a microcontroller, a microprocessor, or any suitable combination of the preceding. The processor 162 is communicatively coupled to, and in signal communication with, the memory 166. The one or more processors are configured to process data and may be implemented in hardware or software. For example, the processor 162 may be 8-bit, 16-bit, 32-bit, 64-bit or of any other suitable architecture. The processor 162 may include an arithmetic logic unit (ALU) for performing arithmetic and logic operations, processor registers that supply operands to the ALU and store the results of ALU operations, and a control unit that fetches instructions from memory 166 and executes them by directing the coordinated operations of the ALU, registers, and other components. The processor 162 may include other hardware and software that operates to process information, control the refrigeration system 100, and perform any of the functions described herein. The processor 162 may be configured to execute software instructions to perform operations of the controller 160. For example, the processor 162 may be configured to execute the software instructions 168 to cause the refrigeration system 100 to perform one or more of its operations described herein. The processor 162 may execute code/software instructions 168 to perform any of its operations. The processor 162 is not limited to a single processing device and may encompass multiple processing devices. The processor 162 may be configured to perform one or more operations of the controller 160 described in FIG. 1, one or more operations of the operational flow for operating in the charging cycle described in FIG. 3A, one or more operations of the operational flow for operating in the discharging cycle described in FIG. 3B, one or more operations of the method 400 described in FIG. 4, and one or more operations of the method 500 described in FIG. 5.

The memory 166 may be a non-transitory computer-readable medium. The memory 166 may include one or more disks, tape drives, or solid-state drives, and may be used as an overflow data storage device, to store programs when such programs are selected for execution, and to store instructions and data that are read during program execution. The memory 166 may be volatile or non-volatile and may comprise a read-only memory (ROM), random-access memory (RAM), ternary content-addressable memory (TCAM), dynamic random-access memory (DRAM), and static random-access memory (SRAM). The memory 166 is operable to store any suitable set of instructions, logic, rules, and/or code for executing the functions described in this disclosure. For example, the memory 166 may store and retrieve information corresponding to software instructions 168, electronic signals 170a-c, temperature data 172, pressure data 174, threshold pressure level 176, and/or other data, instructions, and operating parameters for components in the system 100.

The I/O interface 164 is configured to communicate data and signals with other devices. For example, the I/O interface 164 may be configured to communicate electrical signals with the other components of the refrigeration systems 100. The I/O interface 164 may comprise ports and/or terminals for establishing signal communications between the controller 160 and other devices. The I/O interface 164 may be configured to enable wired and/or wireless communications. Connections between various components of the refrigeration system 100 and between components of system 100 may be wired or wireless. For example, conventional cables and contacts may be used to couple the controller 160 and various components of the refrigeration system 100.

In some embodiments, a wireless connection may be employed to provide at least some or all of the connections between components of the refrigeration system 100. In some embodiments, a data bus may couple various components of the refrigeration system 100 together such that data is communicated therebetween. In some embodiments, the data bus may include, for example, any combination of hardware, software embedded in a computer-readable medium, or encoded logic incorporated in hardware or otherwise stored (e.g., firmware) to couple components of the refrigeration system 100 to each other.

As an example and not by way of limitation, the data bus may include an accelerated graphics port (AGP) or other graphics bus, a controller area network (CAN) bus, a front-side bus (FSB), a hypertransport (HT) interconnect, an InfiniBand ™ interconnect, a low-pin-count (LPC) bus, a memory bus, a micro channel architecture (MCA) bus, a peripheral component interconnect (PCI) bus, a PCI-Express (PCI-X) bus, a serial advanced technology attachment (SATA) bus, a video electronics standards association local bus (VLB), or any other suitable bus or a combination of two or more of these. In various embodiments, the data bus may include any number, type, or configuration of data buses, where appropriate. In certain embodiments, one or more data buses (which may each include an address bus and a data bus) may couple the controller 160 to other components of the refrigeration system 100.

### Operational Flow for Operating the Refrigeration System

In operation, the refrigeration system 100 may be controlled by the controller 160 to provide conditioning to target spaces and execute the charging and discharging cycles of the PCM tank 132 based on the pressure data 174 received from the pressure sensor circuit 144, the temperature data 172 received from the temperature sensor circuit 142 as needed to regulate and control the pressure level within the flash tank 112.

In a conditioning operation, the refrigerant flows through the refrigeration system 100 in a continuous cycle to provide conditioning (e.g., cooling) to the target spaces adjacent to the MT indoor heat exchanger 120 and the LT indoor heat exchanger 122. The refrigerant flow begins at the flash tank 112. In response to a conditioning demand, the valves 116 and 118 may open (e.g., either due to their internally mechanically calibrated settings or a signal from the controller 160) to allow the refrigerant to flow from the flash tank 112. The flow of refrigerant is driven by the pressure differential created by the MT compressor 126 and the LT compressor 124, which pull refrigerant through the system. In response, the liquid refrigerant flows from the flash tank 112 toward the MT indoor heat exchanger 120 through the valve 116 and the LT indoor heat exchanger 122 through the valve 118. Within each of the MT indoor heat exchanger 120 and LT indoor heat exchanger 122, the refrigerant absorbs heat from the respective target space and cools the surrounding air, thereby conditioning the respective target space. As the refrigerant absorbs heat, it transitions into a vapor.

The refrigerant flows from the LT indoor heat exchanger 122 toward the LT compressor 124, and from the MT indoor heat exchanger 120 toward the MT compressor 126. The LT compressor 124 compresses the vapor refrigerant and provides the vapor refrigerant to the suction line 127 of the MT compressor 126. The vapor refrigerant may also flow from the outlet 138c of the flash tank 112 toward the suction line 127 of the MT compressor 126 via the valve 148. The MT compressor 126 compresses the received refrigerant and the compressed refrigerant then flows toward the outdoor heat exchanger 130, where it releases the absorbed heat into the outdoor environment. Once the refrigerant is cooled, it flows toward the valve 146, where its pressure is reduced and the refrigerant flows back into the flash tank 112 to repeat the conditioning cycle. Throughout this process, the controller 160 monitors and adjusts various components, such as valves and compressors as needed to meet the conditioning demand.

### Charging Cycle

FIG. 3A illustrates an operational flow of the refrigeration system 100 of FIG. 1 for operating in the charging cycle 310 of the PCM tank 132. In some embodiments, the controller 160 may operate in the charging cycle of the PCM tank 132 when the system 100 is operating in a conditioning operation described above. For example, the controller 160 may determine to operate in the charging cycle of the PCM tank 132 if the system conditions indicate that the normal cooling condition for target space(s) is in progress. In other words, if the refrigeration system 100 is providing cooling to the target space (e.g., via the LT indoor heat exchanger (122 in FIG. 1)) and/or the MT indoor heat exchanger (120 in FIG. 1), the controller 160 may initiate the charging cycle 310 of the PCM tank 132.

In some embodiments, the controller 160 may determine whether to trigger/operate in the charging cycle 310 of the PCM tank 132 based on system conditions and/or pressure level of the refrigerant within the flash tank 112. For example, the controller 160 may receive the pressure data 174 from the pressure sensor circuit 144 and determine whether the pressure of the refrigerant within the flash tank 112 is more or less than a threshold pressure level (176 in FIG. 1) (e.g., a pressure set point under which the flash tank 112 is configured to operate). If the controller 160 determines that the pressure of the refrigerant is less than the threshold pressure level 176, the controller 160 may trigger the charging cycle 310 to cool the PCM within the PCM tank 132 for pressure regulation of the flash tank 112 as needed. In the same or another example, the controller 160 may determine to operate in the charging cycle 310 when the temperature of the PCM inside the PCM tank 132 is more than a threshold temperature level (e.g., more than 0° C. (32° F.) if PCM is water) based on the temperature data 172 received from the temperature sensor circuit 142.

During the charging cycle 310, the valves 150 and 152 are closed, and the valves 114, 140, and 149 are at least partially open. In some embodiments, this configuration of valves may be implemented by any suitable method. One of the possible methods to implement this configuration of valves is described below, however, one of ordinary skill in the art would recognize other possible methods to implement this or similar valve configurations. To initiate the charging cycle 310 of the PCM tank 132, the controller 160 may send an electronic signal 170a to at least partially open the fourth valve 114 to allow the flow of the refrigerant from the flash tank 112 toward the PCM tank 132 via the fourth valve 114. The third valve 140 may be mechanically calibrated to at least partially open when the pressure differential across the third valve 140 is more than a predefined threshold value. Each of the first valve 150 and the second valve 152 may be mechanically calibrated to close during the charging cycle 310, e.g., when they receive power from the controller 160 or a power outlet.

In response to the valves 114 and 140 being at least partially opened, the refrigerant in liquid form flows from the second outlet 138b of the flash tank 112 toward the second inlet 134b of the PCM tank 132. As the refrigerant flows through the third valve 140, it may expand and cool, and its temperature is reduced. The cooled refrigerant may enter the PCM tank 132 through the second inlet 134b and flow inside the internal pipes or tubes 154. The refrigerant may absorb heat from the PCM stored within the PCM tank 132, which causes the PCM to cool and transition from a liquid to a solid phase (e.g., forming ice if the PCM is water). During the heat exchange between the PCM and refrigerant, at least some of the refrigerant may warm and change from a liquid to a vapor phase. The vapor refrigerant may exit the PCM tank 132 through the second outlet 136b and flow toward the suction line 127 of the MT compressor 126 via the valve 149. This process leads to storing cooled PCM, which can later be used to manage pressure levels within the flash tank 112 as needed. To continue the conditioning operation, the refrigerant in liquid form may flow from the second outlet 138b of the flash tank 112 toward the valves 116 and 118, and circulate through the refrigeration system, similar to that described above.

Referring back to FIG. 1, the MT compressor 126 may compress the received refrigerant to increase its pressure and temperature, and provide it to the outdoor heat exchanger 130 to recirculate the refrigerant back to the flash tank 112 through the valve 146. The controller 160 may monitor the temperature of the PCM within the PCM tank 132 based on the temperature data 172 received from the temperature sensor circuit 142. If the controller 160 determines, based on temperature data 172, that the PCM has reached a desired temperature level (e.g., at or below its freezing point, such as at or below 0° C. (32° F.) if PCM is water), the controller 160 may end the charging cycle (310 in FIG. 3A) by sending an electronic signal 170b to close the fourth valve 114. In some embodiments, if an EEV is implemented for the valve 114, the valve 140 may not be needed.

### Discharging Cycle

FIG. 3B illustrates an example operational flow of the system 100 for operating in the discharging cycle 320 of the PCM tank 132. In some embodiments, the controller 160 may determine whether to trigger/operate in the discharging cycle 320 of the PCM tank 132 based on certain conditions, such as the pressure level of the refrigerant within the flash tank 112, a detection of a power failure or a power disconnection, or an initiation of scheduled maintenance for the refrigeration system 100. For example, the controller 160 may receive the pressure data 174 from the pressure sensor circuit 144 and determine whether the pressure of the refrigerant within the flash tank 112 is more than a threshold pressure level (176 in FIG. 1) (e.g., a pressure set point beyond which the flash tank 112 is not designed to operate). If the controller 160 determines that the pressure of the refrigerant inside the flash tank 112 is more than the threshold pressure level 176, the controller 160 may trigger the discharging cycle 320 to utilize the stored cooled PCM within the PCM tank 132 to reduce the temperature and pressure of the refrigerant within the flash tank 112.

In another example, the controller 160 may determine to trigger or operate in the discharging cycle 320 of the PCM tank 132 upon detecting a power failure. For example, the controller 160 may monitor the power level of the refrigeration system 100 and if the refrigeration system 100 loses power and cannot operate under normal conditions, the controller 160 may initiate the discharging cycle 320 to maintain the predefined desired pressure level within the flash tank 112 using the cooled PCM stored in the PCM tank 132. In another example, the controller 160 may determine to operate in the discharging cycle 320 when the controller 160 detects that a scheduled maintenance for the refrigeration system 100 has started. In the same or another example, the controller 160 may determine to operate in the discharging cycle 320 when the temperature of the PCM inside the PCM tank 132 is less than a threshold temperature level (e.g., less than 0° C. (32° F.) if PCM is water) based on the temperature data 172 received from the temperature sensor circuit 142.

During the discharging cycle 320, the valves 150 and 152 are at least partially open, and the valves 114, 140, and 149 are closed. In some embodiment, this configuration of valves may be implemented by any suitable method. One of the possible methods to implement this configuration of valves is described below, however, one of ordinary skill in the art would recognize other possible methods to implement this or similar valve configurations. To initiate the discharging cycle 320 of the PCM tank 132, the controller 160 may send an electronic signal 170c to close the fourth valve 114. In some embodiments, the electronic signal 170c may cause the fourth valve 114 to close. Thus, the closed fourth valve 114 may prevent the flow of refrigerant toward the PCM tank 132 from the flash tank 112 via the outlet 138b. In some embodiments, the valve 140 may be mechanically calibrated when the pressure differential across the valve is less than a threshold, which may occur when the valve 114 is closed. The valve 149 may be mechanically calibrated to close when the pressure differential across the valve is less than a threshold, which may occur when the valve 149 is closed when operating in the discharging cycle 320 of the PCM tank 132. Each of the first valve 150 and the second valve 152 may be mechanically calibrated to at least partially open when operating in the discharging cycle 320 of the PCM tank 132, e.g., in response to a pressure differential condition across each valve being met and/or in response to a power disconnection to each valve. In response, the vapor refrigerant flows from the outlet 138a of the flash tank 112 toward the first inlet 134a of the PCM tank 132 via the first valve 150 and continues to flow through the internal pipes or tubes 154 inside the PCM tank 132.

As the vapor refrigerant flows through the internal pipes or tubes 154, it may exchange heat with the PCM. The PCM may absorb heat from the refrigerant, which causes the temperature of the refrigerant to decrease. In response to the heat exchange process between the refrigerant and PCM, the refrigerant is condensed into a liquid phase and the PCM transitions from a solid to a liquid state (e.g., the ice is melted if the PCM is water). The cooled liquid refrigerant may exit the PCM tank 132 through the first outlet 136a and flow toward the first inlet 139 of the flash tank 112 via the second valve 152. This flow of cooled liquid refrigerant back to the flash tank 112 may reduce the temperature and pressure of the refrigerant within the flash tank 112. The discharging cycle 320 may continue until the pressure of the refrigerant inside the flash tank 112 is determined to be equal to or less than a predefined desired pressure level.

During the discharging cycle 320, the controller 160 may monitor the pressure level of the refrigerant within the flash tank 112 based on the pressure data 174 received from the pressure sensor circuit 144. If the controller 160 determines that the pressure of the refrigerant within the flash tank 112 has decreased to at or below the threshold pressure level 176, the discharging cycle may end. For example, the discharging cycle may end when the first valve 150 and the second valve 152 are closed. Each of the first valve 150 and the second valve 152 may be mechanically calibrated to close when the pressure differential across the respective valve decreases below a predefined desired pressure differential which corresponds to the difference between the pressure level at the flash tank 112 and the pressure level within the PCM tank 132. In some embodiments, after the discharging cycle 320 is completed, the refrigeration system may resume conditioning operations according to conditioning demands, e.g., during which the refrigerant may flow from the flash tank 112 to valves 116 and 118, and circulate through the refrigeration system, similar to that described above.

### Example Method for Operating a Charging Cycle of a PCM Tank

FIG. 4 illustrates a flowchart of an example method 400 of operating a charging cycle 310 of a PCM tank 132 of the system 100 of FIG. 1. The method 400 may be performed by the controller 160 (see FIG. 1) when one or more processors (e.g., processor 162 of FIG. 1) execute software instructions (e.g., software instructions 168) stored in one or more memories (e.g., memory 166 of FIG. 1). The method 400 may include operations 402-406. Modifications, additions, or omissions may be made to method 400. Method 400 may include more, fewer, or other operations. For example, operations may be performed in parallel or in any suitable order.

At operation 402, the controller 160 may receive pressure data 174 from a pressure sensor circuit 144, where the pressure data 174 indicates the pressure of the refrigerant within a flash tank 112, similar to that described in FIGS. 1 and 3A.

At operation 404, the controller 160 may determine whether to operate in a charging cycle 310 of a PCM tank 132, similar to that described in FIGS. 1 and 3A, e.g., based on the pressure data 174 and/or system conditions. For example, determining whether to operate in the charging cycle 310 of the PCM tank 132 may include determining that the pressure of the refrigerant inside the flash tank 112 is less than the threshold pressure level 176 and/or the system is operating in a conditioning operation. If the controller 160 determines to operate in the charging cycle 310 of the PCM tank 132, the method 400 proceeds to operation 406. Otherwise, the method 400 returns to operation 402, where the controller 160 continues to monitor the pressure of the refrigerant inside the flash tank 112.

At operation 406, the controller 160 communicates an electronic signal 170a to a valve 114 to at least partially open the valve 114 to allow the refrigerant in liquid form to flow from the flash tank 112 toward an inlet 134b of the PCM tank 132. During the charging cycle 310, the valves 150 and 152 are closed and the valves 114, 140, and 149 are at least partially open, similar to that described in FIGS. 1 and 3A.

### Example Method for Operating a Discharging Cycle of a PCM Tank

FIG. 5 illustrates a flowchart of an example method 500 of operating a discharging cycle 320 of a PCM tank 132 of the system 100 of FIG. 1. The method 500 may be performed by the controller 160 (see FIG. 1) when one or more processors (e.g., processor 162 of FIG. 1) execute software instructions (e.g., software instructions 168) stored in one or more memories (e.g., memory 166 of FIG. 1). The method 500 may include operations 502-504. Modifications, additions, or omissions may be made to method 500. Method 500 may include more, fewer, or other operations. For example, operations may be performed in parallel or in any suitable order.

At operation 502, the controller 160 may determine whether a condition to operate in a discharging cycle 320 of the PCM tank 132 is met, similar to that described in FIGS. 1 and 3B. If it is determined that the condition to operate in the discharging cycle 320 of the PCM tank 132 is met, the method 500 proceeds to operation 504. Otherwise, the method 500 may remain in operation 502 to monitor the system conditions until condition associated with the discharging cycle 320 is satisfied.

At operation 504, the controller 160 may communicate an electronic signal 170c to a valve 114 to close the valve 114 to prevent the flow of liquid refrigerant from the valve 114 to the PCM tank 132 via the valve 114, where during the discharging cycle 320, the refrigerant in vapor form flows from the flash tank 112 to the PCM tank 132, is cooled by a PCM, and flows back to the flash tank 112, similar to that described in FIGS. 1 and 3B. During the discharging cycle 320, the valves 150 and 152 are at least partially open and the valves 114, 140, and 149 are closed, similar to that described in FIGS. 1 and 3B.

Although this disclosure has been described in terms of certain embodiments, alterations, and permutations, embodiments will be apparent to those skilled in the art. Accordingly, the above description of the embodiments does not constrain this disclosure. Other changes, substitutions, and alterations are possible without departing from the spirit and scope of this disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

What is claimed is:

1. A refrigeration system comprising:
a phase change material (PCM) tank configured to store a PCM, the PCM configured to change phases between liquid and solid phases, the PCM tank comprising:
a first inlet positioned downstream of a first outlet of a flash tank via a first valve;
a first outlet positioned upstream of a first inlet of the flash tank via a second valve;
a second inlet positioned downstream of a third valve, wherein the third valve is positioned downstream of a fourth valve which is fluidly connected to a second outlet of the flash tank;
a second outlet positioned downstream of a suction line of a compressor; and
an internal tube in which refrigerant is stored;
the flash tank fluidly coupled with the PCM tank, and configured to store a mixture of refrigerant in vapor form and liquid form;
the third valve configured to expand the refrigerant as the refrigerant flows through the third valve, thereby causing a temperature of the refrigerant to be reduced;
a pressure sensor circuit positioned within the flash tank, and configured to detect a pressure of the refrigerant within the flash tank; and
a controller operably coupled with the pressure sensor circuit, the controller comprising a processor configured to:
receive pressure data from the pressure sensor circuit, wherein the pressure data indicates the pressure of the refrigerant within the flash tank;
determine to operate in a charging cycle of the PCM tank based at least in part upon the received pressure data, wherein determining whether to operate in the charging cycle of the PCM tank comprises determining that the pressure of the refrigerant is less than a threshold pressure level; and
in response to determining to operate in the charging cycle of the PCM tank, communicate a first electronic signal to the fourth valve to at least partially open the fourth valve to allow the refrigerant in liquid form to flow from the flash tank to the second inlet of the PCM tank, wherein in response to the fourth valve be at least partially opened:
the refrigerant in liquid form flows from the flash tank toward the second inlet of the PCM tank via the fourth valve and the third valve;
within the PCM tank, the refrigerant absorbs heat from the PCM and changes into vapor refrigerant; and
the vapor refrigerant flows from the second outlet of the PCM toward the suction line of the compressor, and
wherein during the charging cycle of the PCM tank, the first valve and the second valve are closed.

2. The refrigeration system of claim 1, wherein the PCM tank further comprises an insulated enclosure formed of polyurethane foam (PUF).

3. The refrigeration system of claim 1, further comprising a temperature sensor circuit positioned within the PCM tank, and configured to detect a temperature of the PCM within the PCM tank.

4. The refrigeration system of claim 3, wherein the processor is further configured to:
receive temperature data from the temperature sensor circuit, wherein the temperature data indicates the temperature of the PCM;
determine to end the charging cycle, wherein determining to end the charging cycle comprises determining that the temperature of the PCM is less than a threshold temperature level; and
in response to determining to end the charging cycle, communicate a second electronic signal to the fourth valve to close the fourth valve.

5. The refrigeration system of claim 4, wherein the threshold temperature level of the PCM is a temperature at or below a freezing point of the PCM.

6. The refrigeration system of claim 1, wherein the PCM comprises water.

7. The refrigeration system of claim 1, wherein the internal tube within the PCM tank is made of copper or copper alloy.

8. A method for operating a refrigeration system, comprising:
storing a phase change material (PCM) in a PCM tank, the PCM configured to change phases between liquid and solid phases, the PCM tank comprising:
a first inlet positioned downstream of a first outlet of a flash tank via a first valve;
a first outlet positioned upstream of a first inlet of the flash tank via a second valve;
a second inlet positioned downstream of a third valve, wherein the third valve is positioned downstream of a fourth valve which is fluidly connected to a second outlet of the flash tank;
a second outlet positioned downstream of a suction line of a compressor; and
an internal tube in which refrigerant is stored;
storing, in the flash tank, a mixture of refrigerant in vapor form and liquid form;
expanding, by the third valve, the refrigerant as the refrigerant flows through the third valve, thereby causing a temperature of the refrigerant to be reduced;
detecting, by pressure sensor circuit positioned within the flash tank, a pressure of the refrigerant within the flash tank;
receiving, by a processor, pressure data from the pressure sensor circuit, wherein the pressure data indicates the pressure of the refrigerant within the flash tank;
determining, by the processor, to operate in a charging cycle of the PCM tank based at least in part upon the received pressure data, wherein determining whether to operate in the charging cycle of the PCM tank comprises determining that the pressure of the refrigerant is less than a threshold pressure level; and
in response to determining to operate in the charging cycle of the PCM tank, communicating, by the processor, a first electronic signal to the fourth valve to at least partially open the fourth valve to allow the refrigerant in liquid form to flow from the flash tank to the second inlet of the PCM tank, wherein in response to the fourth valve be at least partially opened:
the refrigerant in liquid form flows from the flash tank toward the second inlet of the PCM tank via the fourth valve and the third valve;
within the PCM tank, the refrigerant absorbs heat from the PCM and changes into vapor refrigerant; and
the vapor refrigerant flows from the second outlet of the PCM toward the suction line of the compressor, and
wherein during the charging cycle of the PCM tank, the first valve and the second valve are closed.

9. The method of claim 8, wherein the PCM tank further comprises an insulated enclosure formed of polyurethane foam (PUF).

10. The method of claim 8, further comprising detecting, by a temperature sensor circuit positioned within the PCM tank, a temperature of the PCM within the PCM tank.

11. The method of claim 10, further comprising:
receiving, by the processor, temperature data from the temperature sensor circuit, wherein the temperature data indicates the temperature of the PCM;
determining, by the processor, to end the charging cycle, wherein determining to end the charging cycle comprises determining that the temperature of the PCM is less than a threshold temperature level; and
in response to determining to end the charging cycle, communicating, by the processor, a second electronic signal to the fourth valve to close the fourth valve.

12. The method of claim 11, wherein the threshold temperature level of the PCM is a temperature at or below a freezing point of the PCM.

13. The method of claim 8, wherein the PCM comprises water.

14. The method of claim 8, wherein the internal tube within the PCM tank is made of copper or copper alloy.

15. A controller for a refrigeration system, the controller comprising a processor configured to:
receive pressure data from a pressure sensor circuit, wherein the pressure data indicates a pressure of refrigerant within a flash tank;
determine to operate in a charging cycle of a phase change material (PCM) tank based at least in part upon the received pressure data, wherein determining whether to operate in the charging cycle of the PCM tank comprises determining that the pressure of the refrigerant is less than a threshold pressure level, wherein the PCM tank comprising:
a first inlet positioned downstream of a first outlet of the flash tank via a first valve;
a first outlet positioned upstream of a first inlet of the flash tank via a second valve;
a second inlet positioned downstream of a third valve, wherein the third valve is positioned downstream of a fourth valve which is fluidly connected to a second outlet of the flash tank;
a second outlet positioned downstream of a suction line of a compressor; and
an internal tube in which the refrigerant is stored; and
in response to determining to operate in the charging cycle of the PCM tank, communicate a first electronic signal to the fourth valve to at least partially open the fourth valve to allow the refrigerant in liquid form to flow from the flash tank to the second inlet of the PCM tank, wherein in response to the fourth valve be at least partially opened:
the refrigerant in liquid form flows from the flash tank toward the second inlet of the PCM tank via the fourth valve and the third valve;
within the PCM tank, the refrigerant absorbs heat from the PCM and changes into vapor refrigerant; and
the vapor refrigerant flows from the second outlet of the PCM toward the suction line of the compressor, and
wherein during the charging cycle of the PCM tank, the first valve and the second valve are closed.

16. The controller of claim 15, wherein the PCM tank further comprises an insulated enclosure formed of polyurethane foam (PUF).

17. The controller of claim 15, wherein the processor is further configured to:
receive temperature data from a temperature sensor circuit, wherein the temperature data indicates a temperature of the PCM;
determine to end the charging cycle, wherein determining to end the charging cycle comprises determining that the temperature of the PCM is less than a threshold temperature level; and
in response to determining to end the charging cycle, communicate a second electronic signal to the fourth valve to close the fourth valve.

18. The controller of claim 17, wherein the threshold temperature level of the PCM is a temperature at or below a freezing point of the PCM.

19. The controller of claim 15, wherein the PCM comprises water.

20. The controller of claim 15, wherein the internal tube within the PCM tank is made of copper or copper alloy.
